(19) United States
(12) Patent Application Publication
(10) Pub. No.: US 2005/0107276 A1
(43) Pub. Date: May 19, 2005

(54) Carpet treatment with chlorine dioxide for mold/milldew remediation

(76) Inventors: Colleen Diane Merritt, Wilmington, DE (US); Pallav Tatapudi, Hockessin, DE (US); Carl William Erkenbrecher JR., Elkton, MD (US); Thomas Harold Samples, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/712,111

(22) Filed: Nov. 13, 2003

(51) Int. Cl. C11D 1/00

(52) U.S. Cl. 510/278

(57) ABSTRACT

A method of cleaning carpet to kill fungi and bacteria so as to achieve a total bioburden reduction of at least 0.3 log, comprising contacting a cleaning composition containing chlorine dioxide or its precursors with the carpet is disclosed.

### FIELD OF THE INVENTION

This invention relates to a process for killing bacteria and fungi, particularly mold and mildew, in carpets.

### BACKGROUND OF THE INVENTION

Mold and mildew in carpets can be the source of serious health problems to building inhabitants. Typical cleaning methods used on mold and mildew-contaminated carpets are largely ineffective in removing biological contamination, referred to hereinafter as the bioburden of the carpets. When health problems develop, and the carpet has been identified or perceived as the source of the problem, the entire carpet is typically removed and destroyed, and replaced with new carpeting. In the case of schools, hotels and other public or commercial establishments, where the amount of carpeting may be large, this operation is costly and renders the area unusable for the period of renovation.

Various methods have been proposed for cleaning carpets to remove soils or stains. See, for example, U.S. patent application Publication US 2003/0070692A1. However, the prior art methods utilize compositions containing active oxygen compounds such as hydrogen peroxide, other peroxides, or peroxy compounds. It is desired to have a method and composition for killing bacteria and fungi, particularly mold and mildew, in carpets. It is also desired to have a method which uses a composition which is highly efficient at low concentrations to avoid adversely affecting or damaging the carpet. The present invention provides such a method and composition.

### SUMMARY OF THE INVENTION

This invention relates to a method of cleaning carpet to kill fungi and bacteria comprising contacting a cleaning composition containing chlorine dioxide or precursors thereof with the carpet thereby reducing total bioburden by at least 0.3 log.

The present invention further comprises a cleaning composition for carpet comprising chlorine dioxide or precursors thereof.

### DETAILED DESCRIPTION OF THE INVENTION

Trademarks are shown herein by capitalization.

This invention provides a method of cleaning carpet that has become contaminated with fungi and bacteria. A reduction of about 0.3 log (corresponding to about 50% reduction) in total bioburden is considered to be the minimum amount to achieve a measurable, significant reduction. The method of this invention has been shown to achieve a 0.3 log reduction, preferably a 0.5 log reduction, more preferably about a 0.7 log reduction, and under optimum conditions, over a 1.1 log reduction in total bioburden. As such, it is a major advance over previously disclosed carpet cleaning methods that were aimed primarily at soil and stain removal.

The method of the present invention comprises contacting a cleaning composition containing chlorine dioxide, or its precursors under conditions to generate chlorine dioxide in situ, with the carpet. In contrast to prior art methods employing active oxygen compounds, chlorine dioxide is employed at much lower concentrations and is highly effective at reducing bioburden in carpets.

Suitable compounds for the reaction to generate chlorine dioxide are well known in the art. Various reactant combinations can be used in the method of the present invention. A solid composition which is useful for the controlled release of chlorine dioxide gas at low concentrations of about 0.025 to about 1000 ppm upon exposure to water vapor is prepared by reacting a metal chlorite with a dry solid hydrophilic material such as natural or synthetic zeolites, mordenite, clays, calcined clays, and acidified synthetic zeolites. Such solid compositions are in the form of a powder, pellets, or formed shapes. See, for example, U.S. Pat. No. 6,077,495.

To generate chlorine dioxide gas in solution, the subject process preferably utilizes an alkaline chlorite and gaseous chlorine as the reactants. Sodium chlorite is the preferred alkaline chlorite reactant, with a 25% solution of sodium chlorite being most practical. Once the reactant compounds are introduced into water, the compounds are completely mixed, preferably by passage through a static mixer. Upon commingling the reactant compounds with water, they react to thereby generate chlorine dioxide in high yields. The generation of chlorine dioxide in the water forms a chlorine dioxide solution. The generation of the chlorine dioxide in the water immediately dilutes the hazardous gas, avoiding any potential problems. The reaction preferably occurs in a controlled manner providing sufficient retention time to provide high yields of chlorine dioxide. The monitoring of the pH permits the generation of a quality chlorine dioxide product under optimal conditions. See, for example, U.S. Pat. No. 5,009,875. The chlorine dioxide solution is then incorporated into a cleaning composition.

The cleaning composition of the present invention is thus liquid or solid in form. It further comprises a variety of optional components including a surfactant, emulsifier, water and additives.

The composition typically includes at least one cleaning agent which is preferably a surfactant or surfactant system. A variety of surfactants, or mixtures of surfactants, are suitable for use herein. Suitable surfactants include cationic, anionic, nonionic, and zwitterionic surfactants, which are commercially available from a number of sources. For a discussion of surfactants, see Kirk-Othmer, Encyclopedia of Chemical Technology, Third Edition, volume 8, pages 900-912. Preferred surfactants include cationic surfactants such as alkyl dimethyl ammonium chloride or alkyl dimethyl ammonium halides. Biocidal cationic surfactants such as dodecyl dimethyl ammonium chloride, or quaternary ammonium chloride compounds, are especially useful herein. Detergent systems to aid in cleaning which are compatible with such compounds are preferred.

Anionic surfactants useful in the present cleaning compositions, include, for example, carboxylates such as alkylcarboxylates (carboxylic acid salts) and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkysulfates, sulfosuccinates, alkylether sulfates, and the like; and phosphate esters such as alkylphosphate esters, and the like. Preferred anionics are sodium alkylarylsulfonate, alpha-olefin sulfonate, and fatty alcohol sulfates which are compatible with the quaternary or cationic surfactant. Examples of preferred anionic surfactants include sodium dodecylbenzene sulfonic acid, potassium laureth-7 sulfate, and sodium tetradecenyl sulfonate.

Nonionic surfactants useful in the present cleaning compositions include those having a polyalkylene oxide polymer as a portion of the surfactant molecule. Such nonionic surfactants include, for example, chlorine-, benzyl-, methyl-, ethyl-, propyl-, butyl- and other like alkylcapped polyethylene and/or polypropylene glycol ethers of fatty alcohols; polyalkylene oxide free nonionics such as alkyl polyglycosides; sorbitan and sucrose esters and their ethoxylates; alkoxylated ethylene diamine; carboxylic acid esters such as glycerol esters, polyoxyethylene esters, ethoxylated and glycol esters of fatty acids, and the like; carboxylic amides such as diethanolamine, condensates, monoalkanolamine condensates, polyoxyethylene fatty acid amides, and the like; and ethoxylated amines and ether amines and other like nonionic compounds. Silicone surfactants such as the ABIL B8853 (Goldschmidt) can also be used.

Compositions for carpet cleaning preferably include a low foam surfactant such as a nonionic surfactant or a combination of an anionic surfactant with a defoamer. An amphoteric surfactant can be employed for carpet or upholstery cleaning or sanitizing compositions, but such surfactants typically produce undesirably high levels of foam.

Additives can be included in the cleaning compositions of the present invention for various purposes. Suitable additives include cheating agents (chelators), sequestering agents (sequestrants), detergent builders, and the like. The level of additive can vary widely depending upon the composition and its desired physical form.

Solid (e.g., powder) or agglomerate cleaning compositions of the present invention can further include additional functional materials or additives that provide a beneficial property, for example, to harden the composition in solid form or to aid in dissolution when dispersed, exposed to humidity, or dissolved in an aqueous solution, or to activate the generation of chlorine dioxide when added to water. Examples of conventional additives include one or more of each of salt or additional salt, alkalinity source, acidity source, pH buffer, hardening agent, debrowning agent, solubility modifier, detergent filler, water softener, defoamer, anti-redeposition agent, precipitation threshold agent or system, antimicrobial agent, aesthetic enhancing agent (i.e., dye, odorant, perfume), optical brightener, bleaching agent, enzyme, effervescent agent, activator for the active oxygen compound, tablet dissolution aid, other such additives or functional ingredients, and the like, and mixtures thereof. Adjuvants and other additive ingredients will vary according to the type of composition being manufactured.

Liquid cleaning compositions of the present invention can include further additional functional materials or additives that provide a beneficial property. Examples include alkali halides, metal salts or alkaline earth halides such as potassium chloride or calcium chloride; co-solvents such as alcohols of 1 to 6 carbons such as methanol, ethanol, n-propanol; and buffers such as alkali metal phosphates or alkali metal carbonates.

Some embodiments of the cleaning composition optionally include salt, or one or more additional salts, for example, alkali metal salt. The alkali metal salt can act as an alkalinity source to enhance cleaning of a substrate, and improve soil removal performance of the composition. Additionally, in some embodiments the alkali metal salts can provide for the formation of an additional binder complex or binding agent including: alkali metal salt; organic sequestrant including a phosphonate, an aminocarboxylic acid, or mixtures thereof; and water.

Additionally, in some embodiments, salts, for example acidic salts, can be included as pH modifiers, sources of acidity, effervescing aids, or other like uses. Some examples of salts for use in such applications include sodium bisulfate, sodium acetate, sodium bicarbonate, citric acid salts, and the like and mixtures thereof. It should be understood that agents other than salts that act as pH modifiers, sources of acidity, effervescing aids, or like, can also be used in conjunction with the invention so long as they do not decrease the activity of the chlorine dioxide.

The present compositions can include a minor but effective amount of a secondary hardening agent, as for example, an amide such stearic monoethanolamide or lauric diethanolamide; or an alkylamide, and the like.

An effective amount of a defoaming agent for reducing the stability of foam can also be included in the present cleaning compositions. Preferably, the cleaning composition includes about 0.0001-5 wt-% of a defoaming agent. Examples of defoaming agents suitable for use in the present compositions include silicone compounds such as silica dispersed in polydimethylsiloxane, EO/PO block copolymers, alcohol alkoxylates, fatty amides, hydrocarbon waxes, fatty acids, fatty esters, fatty alcohols, fatty acid soaps, ethoxylates, mineral oils, polyethylene glycol esters, alkyl phosphate esters such as monostearyl phosphate, and the like.

Various dyes, odorants including perfumes, and other aesthetic enhancing agents can also be included in the composition.

Preferably in the inventive method of the present invention, a thorough sweeping cleaning of the carpet to remove any loose or visible dirt is conducted prior to contacting with the cleaning composition. By “loose or visible dirt” is meant dirt that can be seen by inspection or which can be removed by typical carpet cleaning procedures. A typically dirty carpet may have as much as 1 to 5 grams of dirt per square meter removable by vacuuming. We have found that removal of this material is useful so that the treatments are not consumed or wasted on such materials.

For the inventive procedure to be most effective, the removable dirt content on the carpet should be below 1 gram per square meter, preferably no more than 0.10 gram per square meter, and more preferably below 0.02 gram per square meter, measured in a 90 second period using a vacuum pump drawing roughly 15 L/minute of air through a sampling cassette.

The above precleaning may be performed by vacuuming, shampooing and/or steam cleaning. It is preferred that any vacuum cleaning be performed by using a strong vacuum cleaner with an HEPA (High Efficiency Particulate Air) filter. By an HEPA filter, we mean filters of the general type described by U.S. Dept. of Energy Standard DOE-STD-3020-97, although not necessarily one meeting this standard in every detail. An HEPA filter is preferred to prevent vacuumed particulate matter from being released back into the air and resettling on the carpet and carpet substrate. Suitable vacuum cleaners are any of those approved under the Green Label testing program by the Carpet and Rug Institute, a list found on the Internet under “www.carpet-rug.com”.

“Contacting” is used herein to mean applying the solution to the carpet with brushing or working to obtain deep fiber penetration. The cleaning composition is preferably contacted uniformly with the carpet in an amount sufficient to wet a substantial portion of the carpet fibers. It has been found that suitable spraying can be carried out using for example a distribution wand or a power sprayer. One or more surfactants may be added to the cleaning solution to aid in wetting the carpet fibers.

The amount of cleaning solution will vary with the fiber composition, depth of pile and other factors related to carpet construction. The amount should be sufficient to wet the carpet fibers completely without forming a pool of liquid on the carpet substrate. We have found an amount of roughly 1 gallon per 50-200 sq. ft. (4.6-18.6 sq. meters) to be satisfactory for the carpets tested.

The cleaner solution contains an effective concentration of chlorine dioxide or its precursors. By “an effective concentration” is meant a concentration that will kill typical biological contaminants in aqueous solution at room temperature in about 10 minutes. For initial test of a particular cleaner solution, this may be readily determined by laboratory tests, for example, by measuring the kill rate of mold spores on solid surfaces. Most sanitizer tests are run at 10 minutes for hard surfaces. The EPA protocol for bactericidal efficacy on carpet requires 60 minutes treatment time.

The concentration chosen should then be tested on a small portion of the carpet to make sure there is no damage to the carpet color. Many different dyes and dye classes have been used on carpets, and some may be sensitive to cleaning agents, particularly when they are used at higher concentrations. Once a satisfactory concentration is determined by such pretests, a standard concentration may be used, unless trials in a particular environment indicate a need to increase or decrease this concentration.

A specific example of a liquid chlorine dioxide formulation of the present invention is CRYOCIDE 20. It is used as a 1% solution. CRYOCIDE 20 is available from International Dioxcide Inc. located in Providence R.I., and from various distributors. The composition of CRYOCIDE 20 is as follows:

| | Wt % |
|---|---|
| Stabilized Chlorine dioxide | 0.72 |
| Dodecyl Dimethyl Ammonium Chloride | 0.4 |
| Potassium Chloride | 0.08 |
| Isopropanol | 1.00 |
| Neodol 25-12 (emulsifier) | 1.2 |
| Water | 96.6 |

The “Chlorine Dioxide” referred to in Cryocide is buffered sodium chlorite and also referred to as stabilized chlorine dioxide.

An additional specific example of the composition of the present invention is a solid substance containing a chlorine dioxide precursor which generates chlorine dioxide when dissolved in water. A typical concentration range for this product is 5-15 ppm (microgram per gram) of chlorine dioxide. Its composition is approximately as follows:

| | |
|---|---|
| Inorganic Acid | 30-45% |
| Inorganic Salts | 15-40% |
| Clay Microspheres | 15-30% |
| Sodium Chlorite | 5-10% |
| Activator | 0.5-2% |

It is preferred to brush or work the solution into the carpet to obtain deep fiber penetration. This can be effectively done using a carpet scrubbing machine with rotating brushes (such as a Whittaker machine available from R. E. Whittaker Extraordinary Cleaning Systems, New Castle, Pa.) for one to two passes over the carpet. Other machines may also be suitable, as may hand brushing.

The solution is allowed to remain on the carpet for about 10 to about 60 minutes. Preferably the time is about 30 minutes. This will provide adequate time for the solution to work. Shorter amounts of time are not recommended since they may be only partially effective in reducing the bioburden. Longer treatment times are not recommended as this may result in collateral damage to the treated object, such as bleaching.

The following examples are intended to be illustrative of the inventive process, but should not be interpreted as limiting the scope of the invention.

### EXAMPLES

### Example 1

This example is a field trial of carpet treatment prototypes at a school designated as Test Site 3. Tests were on a carpet that had been previously exposed to water that had infiltrated the building. Products tested were the specific examples of liquid and solid formulations previously listed in the specification. The liquid is designated hereafter as Product L and the solid as Product S. Prior to treatment, initial carpet soil samples were collected in duplicate from each of two delineated regions of the same carpet, as follows:

The carpet was divided by tape markings into three regions. A 1-ft by 1-ft (30.5 cm by 30.5 cm) aluminum frame was used as a template for sampling uniform areas of carpet in each of the three regions using air monitor sampling cartridges (37 mm process monitors, 0.45 μm filter; Gelman Sciences 28143-530) attached to a vacuum pump operating with the valve fully opened (drawing roughly 15 L air/min). The area within the template was sampled by passing the cassette over the carpet within the template with uniform pressure and parallel, adjacent strokes until the entire area had been sampled in one direction. The perpendicular direction was sampled in the same way using the same cassette. Lastly, the same cassette was passed over the area in the diagonal direction within the template. Sampling in each direction usually required a 30-second sample rate for a total sample time of approximately 1 minute and 30 seconds. The sample masses were in the range of 0.001-0.020 g carpet soil per sq. ft. (0.001-0.020 g per 30.5 cm by 30.5 cm area).

Treatments were prepared separately and just prior to their use as follows:
a) 2 tablets of Product S were dissolved in one gallon of cool tap water to provide a 10 ppm aqueous solution of ClO₂ (chlorine dioxide).
b) Product L was added to cool tap water to provide a 1% concentration of CRYOCIDE 20, or about 72-80 ppm chlorite.

Treatments were applied using the distribution wand of the hot water extractor with no vacuum suction provided. A Whittaker machine available from R. E. Whittaker Company, New Castle, Pa. (dual rotating brushes) worked the treatment into the carpet in 1-2 passes. Treatments were allowed to react for the times indicated on the spreadsheet in Table 1. The goal for treatment time was 30 minutes but this time was exceeded by 5 minutes for Product L, thus treatment times ranged from 30-35 minutes.

The treatment was removed from the carpet via hot water extraction using tap water with 1-2 passes of the hot water extraction apparatus. The carpet was dried overnight with constant fanning. Carpet soil samples were collected the following morning via the method described above. Four samples were collected from each treated region. An additional sample was collected from the hallway mat. Samples were shipped to an independent laboratory for enumeration and identification of fungi and bacteria.

Collection of enough initial carpet soil for a pre-treatment analysis was very difficult because of the effective precleaning. The pre-treatment samples were combined into a single sample to provide enough mass for the culturing and analysis of microorganisms. A large microbial count was obtained for the total bioburden from the carpet prior to treatment, reaching roughly 4.02×10⁸ CFU/g (8.60 logs), of which 4.01×10⁸ CFU/g was bacteria. Table 1 contains raw data from the enumeration of bacteria and fungi found in each sample in each region of the carpet. For all treatments, the greatest reductions were observed for bacteria. Product S (10 ppm ClO₂) provided an average total bioburden reduction of 93.23%, achieving 1.17 logs and 0.20 log reductions in bacteria and fungi, respectively. A concentration of 1% Product L of about 72-80 ppm chlorite had a smaller effect on the total bioburden, providing only 83.4% reduction in the average total number of microorganisms, predominately bacteria (0.78 log reduction).

The Whittaker machine provided a very useful technique for working the treatments into the carpet fibers and removing soil from the depths of the carpet pile. On the morning following the treatment and after a night of fan drying, a fine dusty residue was noted on the surface of the treated carpet. This residue was most likely carpet soil that was pulled up from the depths of the carpet pile. It may have also contained some treatment residual but this dusty residue was on all of the treated regions. If the dust were due to poor treatment extraction, then it would most likely have appeared on the Product S treated surfaces only; which is a powder formulation prior to dissolving in water. However, the dusty residue could be easily removed by vacuuming, and this residue was captured in the post-treatment samples.

TABLE 1
Test Site 3 Carpet Treatment

| | | | | | CFU/g | | |
|---|---|---|---|---|---|---|---|
| | Before/After | Treatment | Location | Treatment | Fungal | Bacterial | Total |
| Sample | Treatment | Applied | Area | Details | Load* | Load | Micro* |
| A | Before | Product L | 2 | 35 min | A through D | A through D | A through D |
| B | Before | Product L | 2 | 35 min | pooled | pooled | pooled |
| C | Before | Product S | 1 | 30 min | for | for | for |
| D | Before | Product S | 1 | 30 min | analysis | analysis | analysis |
| E | After | Product L | 2 | area dried | 2.20E+05 | 9.18E+07 | 9.21E+07 |
| F | After | Product L | 2 | overnight | 3.20E+05 | 6.56E+07 | 6.59E+07 |
| G | After | Product L | 2 | with fans | 1.73E+05 | 5.74E+07 | 5.76E+07 |
| H | After | Product L | 2 | | 4.40E+05 | 5.08E+07 | 5.13E+07 |
| I | After | Product S | 1 | area dried | 2.00E+05 | 2.60E+06 | 2.80E+06 |
| J | After | Product S | 1 | overnight | 3.60E+05 | 6.80E+05 | 1.04E+06 |
| K | After | Product S | 1 | with fans | 4.00E+04 | 1.05E+08 | 1.05E+08 |
| L | After | Product S | 1 | | 2.00E+02 | 1.92E+03 | 2.12E+03 |
| M-Hall | Before | No treatment | | | 1.20E+05 | 3.44E+07 | 3.46E+07 |
| Mat | | | | | | | |

Note:
In the raw data counts, the yeast counts are excluded.

Yeast counts have been excluded from the fungal enumeration because yeasts are ubiquitous and plentiful in the indoor environment and are rarely problematic with regards to indoor air quality. Yeasts are not considered a typical indoor air quality problem-causing microorganism. In most cases, the yeast counts were much greater than any other fungi, so these counts were excluded to focus on enumeration and reduction of other fungal species.

Below in Table 2 is a list of dominant mold species found in the samples taken from the carpet. The sample letters correspond to the samples and conditions described above in Table 1. Samples A through D were pooled into one sample due to the small amount of dust obtained in each of the individual samples. Log bioburden correlates to the log₁₀ of the number of colony forming units per gram carpet dust sample (CFU/g). The percentage corresponds to the percentage fungi or bacteria in total population from the sample.

TABLE 2
Dominant Mold Species, Test Site 3 Carpet

| | | | Percentage | Log |
|---|---|---|---|---|
| Sample | Treatment | Species | (%) | Bioburden |
| ABCD | Pre-treated | Aspergillus versicolor | 16 | 4.60 |
| | carpet | Aureobadidium pullulans | 16 | 4.60 |
| | | Cladosporium | 40 | 5.00 |
| E | Product L | Aspergillus versicolor | 11 | 4.60 |
| | | Rhodotorula glutinis | 11 | 4.60 |
| | | Sterile fungi | 11 | 4.60 |
| F | Product L | Aureobasidium pullulans | 36 | 5.08 |
| | | Cladosporium | 16 | 4.73 |
| | | Penicillium | 12 | 4.60 |
| | | Phoma | 16 | 4.73 |
| G | Product L | Alternaria alternata | 17 | 4.60 |
| | | Aureobasidium pullulans | 17 | 4.60 |
| | | Sterile fungi | 17 | 4.60 |
| H | Product L | Aspergillus versicolor | 17 | 4.90 |
| | | Cladosporium | 17 | 4.90 |
| | | Sterile fungi | 17 | 4.90 |
| I | Product S | Alternaria alternata | 20 | 4.60 |
| | | Aspergillus ustus | 20 | 4.60 |
| | | Cladosporium | 60 | 5.08 |
| J | Product S | Cladosporium | 17 | 4.90 |
| | | Penicillium | 25 | 5.08 |
| K | Product S | Aureobasidium pullulans | 100 | 4.60 |
| L | Product S | Alternaria alternata | 18 | 1.60 |
| | | Cladosporium | 36 | 1.90 |
| | | Epicoccum nigrum | 27 | 1.78 |
| M | No | Scopulariopsis Brevicaulis | 33 | 4.60 |
| | treatment/ | Sterile fungi | 67 | 4.90 |
| | Hall Mat | | | |

Total bioburden reductions of 93.3% and 83.5% were achieved with Product S and Product L, respectively. All treatments were most effective in reducing the bacterial load, leading to reductions of 2.72, and 0.79 logs, whereas reductions in fungal load were 0.94, and essentially 0 (an insignificantly low value) logs for Product S and Product L, respectively. From visual observation of the treatment process, the Whittaker machine appeared to be successful in delivering the treatment into the carpet pile and bringing dirt to the carpet surface for removal. Dye damage of the carpet was not apparent with any of the treatments.

### Example 2

This trial was carried out at a school designated as Test Site 4.

Tests were carried out using the procedure of Example 1 except as follows: the carpet was divided by tape markings into two regions. Treatments were applied using the power sprayer attachment of the hot water extractor, with the first application pass on the low setting and a second application pass on the high setting. One gallon of treatment was delivered to each area. A Whittaker machine as used in Example 1 worked the treatment into the carpet in 1-2 passes. Treatments were allowed to react for 30 minutes. The treatment was removed from the carpet via hot water extraction using hot tap water with 2 passes of the hot water extraction apparatus in perpendicular directions. The carpet was dried for 1-½ hours with constant fanning. Carpet soil samples were collected the same night via the method described above in Example 1, with the following exceptions. A greater area was sampled by approximately dividing each treatment region into four smaller regions, from each of which a post-treatment sample was taken; a total of four samples were collected from each treated region. Sampling this larger area required approximately 6 minutes per sample.

This carpet was heavily soiled. It was not specially vacuumed prior to treatment based on concern that not enough sample for analysis would be collected (see previous Example). However, a lot of soil was collected from the carpet prior to treatment. The sample masses were in the range of 0.020-0.100 g carpet soil per sq. ft. (30.5 cm by 30.5 cm area).

The Whittaker machine provided a very useful technique for working the treatments into the carpet fibers and removing soil from the depths of the carpet pile. The post-treatment hot water extraction was performed very meticulously and removed a lot of bulk soil; the post-treatment sampling areas were enlarged to obtain enough dust for analysis. No visible collateral damage of the carpet was observed.

The majority of the bioburden was due to bacterial contamination in the carpet. Table 3 contains raw data from the enumeration of bacteria and fungi found in each sample. Table 4 contains data on the dominant mold species. Mean microbial counts were calculated for each treatment for comparison to the re-treatment samples. For all treatments, the greatest reductions were observed in bacterial bioburden. 1% Product L provided a 0.30 log reduction (50.2%) in total number of microorganisms, of which 0.31 log and 0.19 log reductions were achieved on bacteria and fungi, respectively. Product S (10 ppm ClO₂) reduced the total bioburden by 61.7% (0.43 log), achieving 0.42 log and 0.43 log reductions in bacteria and fungi, respectively.

The overall reductions in bioburden were less in this carpet treatment trial than those observed in Example 1. Such results may reflect the activity of the treatment on the total organic load in the carpet. Because the carpet was heavily soiled and not specially vacuumed prior to treatment, the treatments had additional sources of organic loading with which to interact. The additional bulk soil likely lowered the active ingredient concentration in the treatments available for interaction with microbial sources. This additional soil loading led to reductions in the overall effectiveness of the treatments against the microorganisms in the carpet soil.

TABLE 3
Test Site 4 Carpet Treatment

| | | | | | CFU/g | | |
|---|---|---|---|---|---|---|---|
| | Before | Treatment | Location | Treatment | Fungal | Bacterial | Total |
| Sample | or After | Applied | Area | Details | Load* | Load | Micro |
| A | Before | Product S | 2 | 30 min | 2.06E+04 | 2.11E+06 | 2.13E+06 |
| B | Before | Product S | 2 | 30 min | 6.64E+04 | 9.90E+05 | 1.06E+06 |
| C | Before | Product L | 3 | 30 min | 5.61E+04 | 4.12E+06 | 4.18E+06 |
| D | Before | Product L | 3 | 30 min | 5.60E+04 | 3.88E+06 | 3.94E+06 |
| E | After | Product S | 2 | | 7.62E+03 | 1.20E+05 | 1.28E+05 |
| F | After | Product S | 2 | | 3.20E+04 | 1.97E+06 | 2.00E+06 |
| G | After | Product S | 2 | | 1.11E+04 | 1.03E+06 | 1.04E+06 |
| H | After | Product S | 2 | | 1.00E+04 | 5.37E+05 | 5.47E+05 |
| I | After | Product L | 3 | | 3.45E+04 | 3.88E+06 | 3.91E+06 |
| J | After | Product L | 3 | | 1.56E+04 | 8.39E+04 | 9.95E+04 |
| K | After | Product L | 3 | | 3.85E+04 | 8.44E+04 | 1.23E+05 |
| L | After | Product L | 3 | | 1.67E+04 | 6.73E+05 | 6.89E+05 |

Note:
In the raw data counts, the yeast counts are excluded.

Below in Table 4 is a list of dominant fungi found in the samples taken from the carpet:

TABLE 4
Dominant Mold Species, Test Site 4 Carpet

| | | | Percentage | Log |
|---|---|---|---|---|
| Sample | Treatment | Species | (%) | Bioburden |
| A | Pre-treated | Cladosporium | 33 | 4.01 |
| | carpet | Phoma | 28 | 3.94 |
| B | Pre-treated | Aureobasidium pullulans | 28 | 3.85 |
| | carpet | Cladosporium | 26 | 3.81 |
| C | Pre-treated | Aureobasidium pullulans | 19 | 3.74 |
| | carpet | Cladosporium | 19 | 3.74 |
| | | Epicoccum nigrum | 19 | 3.74 |
| D | Pre-treated | Aureobasidium pullulans | 13 | 4.08 |
| | carpet | Cladosporium | 18 | 4.20 |
| E | Pre-treated | Aureobasidium pullulans | 14 | 4.12 |
| | carpet | Cladosporium | 16 | 4.17 |
| F | Pre-treated | Aureobasidium pullulans | 32 | 4.37 |
| | carpet | Cladosporium | 10 | 3.87 |
| | | Phoma | 10 | 3.87 |
| G | Pre-treated | Aureobasidium pullulans | 25 | 4.04 |
| | carpet | Cladosporium | 11 | 3.68 |
| | | Epicoccum nigrum | 9 | 3.61 |
| | | sterile fungi | 11 | 3.68 |
| H | Pre-treated | Aureobasidium pullulans | 33 | 4.31 |
| | carpet | Cladosporium | 7 | 3.64 |
| | | Epicoccum nigrum | 8 | 3.69 |
| | | Phoma | 7 | 3.64 |
| I | Product S | Alternaria alternata | 38 | 3.46 |
| J | Product S | Alternaria alternata | 19 | 3.81 |
| | | Cladosporium | 24 | 3.90 |
| | | Epicoccum nigrum | 19 | 3.81 |
| | | Penicillium | 10 | 3.51 |
| | | Rhodotorula glutinis | 14 | 3.68 |
| K | Product S | Cladosporium | 14 | 3.22 |
| | | Epicoccum nigrum | 18 | 3.34 |
| | | Phoma | 36 | 3.65 |
| L | Product S | Aureobasidium pullulans | 15 | 3.26 |
| | | Cladosporium | 23 | 3.44 |
| | | Phoma | 15 | 3.26 |
| M | Product L | Alternaria alternata | 10 | 3.56 |
| | | Aureobasidium pullulans | 19 | 3.86 |
| | | Cladosporium | 43 | 4.21 |
| | | Epicoccum nigrum | 14 | 3.74 |
| N | Product L | Cladosporium | 17 | 3.47 |
| | | sterile fungi | 33 | 3.77 |
| O | Product L | Aureobasidium pullulans | 14 | 3.77 |
| | | Cladosporium | 57 | 4.37 |
| | | Epicoccum nigrum | 11 | 3.65 |
| P | Product L | Aureobasidium pullulans | 33 | 3.81 |
| | | Cladosporium | 27 | 3.71 |

An overall summary and comparison of the Examples is given below in Table 5.

TABLE 5
Overall Summary of Field Trials.

| | | Fungal | Fungal | % | Bacterial | Bacterial | % | Total | Total | % |
|---|---|---|---|---|---|---|---|---|---|---|
| Ex. | | Bioburden | Bioburden | Fungal | Bioburden | Bioburden | Bacterial | Bioburden | Bioburden | Total |
| No. | TREATMENT | BEFORE | AFTER | Reduction | BEFORE | AFTER | Reduction | BEFORE | AFTER | Reduction |
| Ex. 1 | Product S | 2.40E+05 | 1.50E+05 | 37.5 | 4.02E+08 | 2.71E+07 | 93.3 | 4.02E+08 | 2.72E+07 | 93.2 |
| Ex. 1 | Product L | 2.40E+05 | 2.88E+05 | −20.0 | 4.02E+08 | 6.64E+07 | 83.5 | 4.02E+08 | 6.67E+07 | 83.4 |
| Ex. 2 | Product S | 4.05E+04 | 1.52E+04 | 62.5 | 2.38E+06 | 9.12E+05 | 61.7 | 2.42E+06 | 9.27E+05 | 61.7 |
| Ex. 2 | Product L | 4.05E+04 | 2.63E+04 | 35.1 | 2.38E+06 | 1.18E+06 | 50.4 | 2.42E+06 | 1.21E+06 | 50.2 |

The above table shows the average fungal, bacterial, and total bioburdens of the carpet dust extracted before and after treatments with 10 ppm chlorine dioxide for Product S and 1% Product L (72-80 ppm chlorite) at the venues described in this patent. A negative percentage value indicates that no reduction in bioburden was achieved. The bioburden compositions differ across trials because each carpet has a different history. The microbial bioburden was greater in Example 1 than in Example 2, so the percentages and log reductions correspond to greater numbers of microbes killed by the treatments. If the starting and ending bioburdens are compared in each trial rather than the percentages and log reductions, we can see that the products were more effective in the trial incorporating precleaning (Example 1).

1. A method of cleaning carpet to kill fungi and bacteria comprising contacting a cleaning composition containing chlorine dioxide or precursors thereof with the carpet to reduce total bioburden by at least 0.3 log.

2. The method of claim 1 wherein the cleaning composition contains less than about 80 ppm chlorine dioxide.

3. The method of claim 1 wherein the cleaning composition contains from about 5 ppm to about 15 ppm of chlorine dioxide.

4. The method of claim 1 wherein the cleaning composition reduces total bioburden by at least 0.7 log.

5. The method of claim 1 further comprising removing the removable dirt content on the carpet surface prior to contacting the cleaning composition with the carpet.

6. The method of claim 5 wherein the removable dirt content on the carpet is below 0.10 gram per square meter, measured in a 90 second period using a vacuum pump.

7. The method of claim 1 wherein the cleaning composition further comprises at least one component selected from the group consisting of a surfactant, emulsifier and additive.

8. A composition comprising chlorine dioxide or precursors thereof for cleaning carpet effective to reduce total bioburden by at least 0.3 log.

9. The composition of claim 8 wherein the cleaning composition contains less than 80 ppm chlorine dioxide.

10. The composition of claim 9 containing from about 5 ppm to about 15 ppm of chlorine dioxide.

11. The composition of claim 8 wherein the cleaning composition reduces total bioburden by at least 0.7 log.

12. The composition of claim 8 further comprising at least one component selected from the group consisting of a surfactant, emulsifier and additive.
